(19) United States
(12) Patent Application Publication
(10) Pub. No.: US 2017/0363403 A1
(43) Pub. Date: Dec. 21, 2017

(54) METHOD AND APPARATUS FOR INSPECTING WORKPIECES

(71) Applicant: RENISHAW PLC, Wotton-under-Edge (GB)

(72) Inventor: Kevyn Barry JONAS, Clevedon (GB)

(73) Assignee: RENISHAW PLC, Wotton-under-Edge (GB)

(21) Appl. No.: 15/694,076

(22) Filed: Sep. 1, 2017

Related U.S. Application Data
(63) Continuation-in-part of application No. 14/386,587, filed on Sep. 19, 2014, now abandoned.
Application No. 14/386,587 is a continuation-in-part of application No. PCT/GB2016/050528, filed on Mar. 1, 2016.

(30) Foreign Application Priority Data
Mar. 21, 2012 (GB) 1204947.4
Mar. 2, 2015 (GB) 1503490.3

(51) Int. Cl. G01B 5/00; G01B 5/012

(52) U.S. Cl. CPC G01B 5/0014; G01B 5/012

(57) ABSTRACT

Methods are described for measuring series of nominally identical production workpieces on a dimensional measuring apparatus such as a coordinate measuring machine. One master workpiece of the series is calibrated, to provide correction values which are used to build an error map of the measuring apparatus. This map is used to correct measurements not only of subsequent nominally identical workpieces of the same series, but also of multiple different subsequent series of different workpieces. Each subsequent series also has a master workpiece which is calibrated and used to further build the error map. As this process is repeated over time, the error map becomes more and more densely populated. In due course, it becomes possible to dispense with the use of a calibrated master workpiece, because measurements can be corrected using error values which already exist in the error map.

### FIELD OF THE INVENTION

This invention relates to dimensional measuring apparatus, including coordinate measuring apparatus for inspecting the dimensions of workpieces. It also relates to the calibration of dimensional measuring apparatus. Coordinate measuring apparatus include, for example, coordinate measuring machines (CMM), comparative gauging machines, machine tools, manual coordinate measuring arms and inspection robots.

### DESCRIPTION OF PRIOR ART

After workpieces have been produced, it is known to inspect them on a coordinate measuring apparatus (such as a CMM or a comparative gauging machine) having a movable member supporting a probe, which can be driven within a three-dimensional working volume of the machine.

The CMM (or other coordinate measuring apparatus) may be a so-called Cartesian machine, in which the movable member supporting the probe is mounted via three serially-connected carriages which are respectively movable in three orthogonal directions X, Y, Z. This is an example of a “serial kinematic” motion system. Alternatively, the measuring apparatus may be a non-Cartesian machine, for example having a “parallel kinematic” motion system comprising three or six extensible struts which are each connected in parallel between the movable member and a relatively fixed base member or frame. The movement of the movable member (and thus the probe) in the X, Y, Z working volume is then controlled by coordinating the respective extensions of the three or six struts. An example of a non-Cartesian machine is shown in International Patent Applications WO 03/006837 and WO 2004/063579.

It is known to calibrate such coordinate measuring apparatus by producing an error map or error function relating to the measurement errors experienced throughout its X, Y, Z working volume. This error map or error function is then used to correct measurements made on workpieces.

For example, U.S. Pat. No. 4,819,195 (Bell et al) describes the use of calibration equipment such as laser interferometers, electronic levels, etc in order to produce a map of static errors (i.e. errors which occur even when the apparatus is not moving). This map gives correction values for 21 different sources of static error, for every point in a grid spread over the X, Y, Z working volume.

A less accurate alternative is to use a calibration fixture which comprises a “forest” of multiple balls. These balls are accurately spherical, have accurately known dimensions, and they are mounted in the fixture so as to be spaced in three dimensions with accurately known relationships to each other. The fixture is placed in the working volume of the coordinate measuring apparatus and the balls are measured using the apparatus to move the probe. By comparison with the known dimensions and spacings of the balls, this produces a coarse map of the measurement errors experienced at a grid of points spread over the X, Y, Z working volume. Other calibration artefacts may be used instead of balls, e.g. ring gauges. However, if high accuracy is required, this technique would require the use of a very large number of balls, say 10,000, which is not practical.

Such error maps may take the form of a lookup table of correction values to be applied to measurements at respective points in the grid spread over the X, Y, Z working volume. Optionally, polynomial error functions can be fitted to the errors at these points to determine errors at other points.

U.S. Pat. Nos. 5,594,668 and 5,895,442 (assigned to Zeiss) produce maps of dynamic errors occurring throughout the X, Y, Z working volume. Dynamic errors occur as a result of bending of various parts of the apparatus or the probe during accelerating movements.

Error maps such as described above are used during subsequent measurements of workpieces. The X, Y, Z coordinate measurements taken by the apparatus are corrected, using the corresponding static and/or dynamic errors recorded in the error map for the X, Y, Z position concerned. Or in the case of an error function, the required correction is determined from the value of the function for the X, Y, Z, position concerned.

U.S. Pat. No. 7,079,969 (assigned to Renishaw) corrects for static and dynamic errors without the need for a complete map of such errors over the entire X, Y, Z working volume of the apparatus. A calibrated artefact is nominally identical to workpieces to be measured. It is measured on the coordinate measuring apparatus, at a desired fast speed. The measurements obtained are compared with the dimensions known from the calibration of the artefact. This is used to generate an error map of the static and dynamic errors experienced during the measurement of the artefact. This error map is then used to correct measurements taken subsequently on nominally identical workpieces at the same fast speed.

One advantage of the technique described in U.S. Pat. No. 7,079,969 is that the error map is specific to measurements actually taken on the artefact and the nominally identical workpieces. It is not necessary to map the errors over the entire X, Y, Z volume of the coordinate measuring apparatus. However, as a corollary, further calibration is required if the apparatus is to be used to take accurate measurements on workpieces which have different shapes, and/or which are located in different parts of the working volume of the apparatus, and/or at different measurement speeds. Either the procedure described in U.S. Pat. No. 7,079,969 must be repeated every time new workpieces are to be measured, or a static and/or dynamic error map of the entire machine must be produced.

Our co-pending International Patent Application No. WO 2013/021157 describes methods and apparatus in which one or more error maps, lookup tables or functions are produced, with reference to the temperature of the measurement. Preferably this is done for measurements at two or more temperatures. A master artefact or reference workpiece is measured at each of the temperatures. These error maps, lookup tables or functions are specific to measurements actually taken on the master artefact or reference workpiece, and subsequent nominally identical workpieces.

### SUMMARY OF THE INVENTION

One aspect of the present invention provides a method for measuring production workpieces on a dimensional measuring apparatus, comprising:

taking a production workpiece which is one of a first series of nominally identical workpieces produced by a production process;

measuring the production workpiece on the measuring apparatus;

obtaining calibration values for the production workpiece, from a source external to said measuring apparatus;

comparing the calibration values with the measurement of the workpiece, to produce one or more correction values;

using said correction values to populate or repopulate an error map or lookup table or to calculate or recalculate an error function, for calibrating the measuring apparatus;

measuring one or more further nominally identical workpieces of the first series produced by the production process on the measuring apparatus;

correcting the measurements of the further nominally identical workpieces of the first series using said correction values or the error map or lookup table or error function;

characterised by measuring one or more second workpieces on the measuring apparatus, wherein the second workpiece or workpieces are different from, or are differently located on the apparatus from, the nominally identical workpieces of said first series of workpieces; and

correcting the measurements of the one or more second workpieces using said error map or lookup table or error function.

The production workpieces of the first series may be intended for incorporation into a manufactured product. In an alternative aspect of the invention, an artefact which has features which approximate or match such production workpieces may be used instead of the first-mentioned production workpiece. These features may approximate or match corresponding features of the production workpiece. The correction values and/or calibration values may relate to the features which approximate or match the production workpiece.

Since it relates to a specific series of such workpieces, such an artefact is to be distinguished from standard, general purpose calibration artefacts (such as a calibrated spheres or ring gauges) which are known for use in the calibration of measurement apparatus such as coordinate measuring machines. Such standard calibration artefacts are specially made for general purpose calibration of measurement apparatus, not related to specific production workpieces. Generally, a production workpiece is an item the dimensions of which are to be determined by measurement on the measuring apparatus, whereas the dimensions of a standard calibration artefact are previously known in order to calibrate the apparatus.

The calibration values may be obtained from an external source by calibrating the workpiece or artefact in a separate measurement process, e.g. on a more accurate CMM, roundness measuring machine or other measuring apparatus. Alternatively, the calibration values may be determined from a CAD design file describing the production workpiece (e.g. on the assumption that it has been accurately manufactured).

The correction values may be used directly for correcting the measurements of other workpieces in the first series, or indirectly by using the error map, lookup table or error function.

The correction values may be used to create a new error map or look-up table or to calculate a new error function. Alternatively the correction values may be used to further populate an existing error map or look-up table or to recalculate an existing error function. The existing error map, lookup table or error function may have been created by a conventional calibration of the measuring apparatus, e.g. using standard calibration artefacts such as accurately calibrated balls or ring gauges. Or it may have been created by a previous iteration of the above method according to the invention.

In a preferred form of the method, the second workpiece may form part of one or more further series of workpieces, the workpieces of each series being nominally identical to other workpieces of that series, the workpieces of each series being different from, or being differently located on the apparatus from, the workpieces already measured; the method comprising, for each such different series:

measuring an artefact, the artefact being one of the nominally identical workpieces of that series, or having features the size and shape of which approximate such a workpiece of that series;

obtaining calibration values for the artefact, from a source external to said measuring apparatus;

comparing the calibration values with the measurement of the artefact, to produce one or more correction values; and

using said correction values to further populate said error map or lookup table or recalculate said error function.

In this preferred form of the method, the error map or look-up table or error function may then be used to correct the measurement of subsequent workpieces which are different from those of said first and further series of workpieces or which are differently located on the apparatus.

Preferably the measurements on the first and further series of workpieces take place at the same temperature, to within a predetermined tolerance, so that the error map, lookup table or function relates to that temperature.

A respective error map or lookup table or function may be produced for each of two or more temperatures at which measurements of the calibrated artefact take place. This permits a method wherein the temperature of the measurement of the subsequent workpiece is determined, and then the measurement is corrected using an error map, lookup table or function which corresponds to that temperature to within a predetermined tolerance. Alternatively, the temperature of the measurement of the subsequent workpiece may be determined, and then the measurement may be corrected by interpolation between or extrapolation from two or more of the error maps or lookup tables or functions.

As a further alternative, an error function may be produced which has a term relating to the variation of measurement errors with the temperature at which the measurement takes place. This permits a method wherein the temperature of the measurement of the subsequent workpiece is determined, and then the measurement is corrected using said error function taking account of the temperature.

A further aspect of the invention provides a method for calibrating a measuring apparatus, comprising:

providing an initial error map or initial lookup table or initial error function for calibrating the apparatus, the initial error map or initial lookup table being populated using correction values, or the initial error function being calculated using correction values;

measuring a calibrated workpiece on the measuring apparatus, the workpiece being one of a first series of nominally identical workpieces, or having features the size and shape of which approximate such a workpiece;

comparing the measurement of the workpiece with the calibration of the workpiece to produce one or more further correction values; and

further populating said error map or lookup table or recalculating said error function, using the further error values.

The initial error map or initial lookup table may be populated, or the initial error function may be calculated, by measuring a first calibrated artefact on the measuring apparatus; comparing the measurement of the artefact with the calibration of the artefact to produce one or more correction values; and using said correction values to populate the error map or lookup table or to calculate the error function. The first artefact may be a standard calibration artefact, such as for example a ball or ring gauge, or a fixture comprising a plurality of balls or ring gauges. Such a standard calibration artefact is to be distinguished from a workpiece as discussed above.

Alternatively, the initial error map or initial lookup table may be populated, or the initial error function may be calculated by any known calibration process, e.g. using calibration equipment such as laser interferometers, electronic levels, etc.

Preferably the one or more further correction values are used to correct measurements of other workpieces in the first series. Additionally or alternatively, the error map or look-up table or error function may be used to correct the measurement of subsequent workpieces which are different from those of said first series of workpieces or which are differently located on the apparatus.

In a preferred method, the initial error map or initial lookup table or initial error function relates to errors in measurements taken at a particular temperature, and the measurements on the calibrated workpiece take place at the same temperature. A respective error map or lookup table or function may be produced for each of two or more temperatures.

The temperature of the measurement of a subsequent workpiece may be determined, and then the measurement may be corrected using an error map, lookup table or function corresponding to that temperature. Alternatively, the temperature of the measurement of a subsequent workpiece may be determined, and then the measurement may be corrected by interpolation between or extrapolation from two or more of the error maps or lookup tables or functions.

Preferably, over time, in any aspect of the invention, the apparatus is used to measure further series of workpieces, which are different again (or differently located on the apparatus) from those already measured. This may be part of the normal use of the apparatus by the user to measure production workpieces. For each such different series, a workpiece is calibrated, which may be one of the workpieces of the series, or may have features the size and shape of which approximate such a workpiece. This workpiece is then measured on the measuring apparatus and further error values for the different series are obtained and used to further populate the error map or lookup table, or further recalculate the error function.

As this process is repeated over time, the error map or lookup table becomes more and more densely populated, or the error function is based on more and more values. In due course, when a further different workpiece or series of workpieces is to be measured, it will be possible to dispense with the use of a calibrated workpiece, because measurements can be corrected using error values which already exist in the error map or lookup table, or using the existing error function.

Yet another aspect of the invention provides a method of further calibrating a dimensional measuring apparatus which is calibrated by an initial error map or error function,

the method comprising:

measuring a production workpiece on the measuring apparatus;

comparing the measurements of the production workpiece with calibration values for the production workpiece, obtained from a source external to said measuring apparatus, to produce one or more error values;

determining one or more updated error maps or error functions which combine some or all of the error values with all or part of the initial error map or function;

characterised by:

determining whether one of the updated error maps or error functions gives better correction of measurement errors than the initial error map or error function; and

if an error map or error function is determined to give better correction, then selecting that error map or error function for use in correcting the measurements of one or more further workpieces.

At least in preferred embodiments, the method according to this aspect of the invention thus selects an error map or error function which is based on a combination of error values, rather than blindly incorporating all error values into the error map or error function. The combination of error values has been determined to give better correction of errors than would otherwise be the case.

The production workpiece may be one of a first series of nominally identical workpieces produced by a production process. The initial error map or error function may have been performed in a conventional manner, or it may have been produced by comparing measurements of a calibrated workpiece with corresponding calibration values. Or it may have been produced by an earlier iteration of a method according to the present invention. Thus, the apparatus may “learn” its error map over time, during its normal day-to-day use for measuring workpieces.

One or more further workpieces may be measured, and the measurements thereof corrected using the selected error map or error function. The one or more further workpieces may include production workpieces from the first series of nominally identical workpieces. And/or the one or more further workpieces may include production workpieces from a second series of nominally identical workpieces produced by a production process, which are different from the workpieces of the first series.

In any aspect of the invention, the measuring apparatus may be a coordinate measuring apparatus, such as a coordinate measuring machine. It may be a non-Cartesian coordinate measuring apparatus.

The calibrated workpiece and/or the calibrated artefact may be calibrated by measuring it on a separate, more accurate coordinate measuring machine or other measuring apparatus.

The workpiece measurements may include coordinate measurements of individual points on the surface of the workpiece. And/or the workpiece measurements may include measurements of dimensions of features of the workpiece. These may be derived from such coordinate measurements of points

In any aspect of the invention, where the temperature of a measurement is determined, this may be determined from the temperature of the environment in which the measurement is made, or from the temperature of the apparatus or of the workpiece being measured. The temperature may be measured directly or indirectly.

Further aspects of the invention include measuring apparatus configured to perform any of the above methods, and programs for a computer control of a measuring apparatus, which configure the apparatus to perform any such method. The invention also encompasses a computer-readable medium having computer-executable instructions for causing a computer to perform any such method. More specifically, such a computer-readable medium may be a non-transitory computer-readable medium (or a non-transitory processor-readable medium) having computer-executable instructions or computer code thereon for performing various computer-implemented operations as described herein. The non-transitory computer-readable medium (or processor-readable medium) is non-transitory in the sense that it does not include transitory propagating signals such as a propagating electromagnetic wave carrying information on a transmission medium. Software programs may be recorded on machine readable media such as discs or memory devices, or stored on a remote server for downloading.

An “error map” as discussed in this specification may include, for example, a look-up table of values for the correction of subsequent measurements.

### BRIEF DESCRIPTION OF THE DRAWINGS

Preferred embodiments of the invention will now be described, by way of example, with reference to the accompanying drawings, wherein:

FIG. 1 is a diagrammatic representation of a non-Cartesian coordinate measuring machine (CMM) used in first embodiments of the invention;

FIG. 2 shows diagrammatically a part of a computer control system of the machine of FIG. 1;

FIGS. 3-6 are flowcharts of methods of using the CMM;

FIG. 7 shows operative parts of a comparative gauging machine used in further embodiments of the invention;

FIGS. 8 and 9 are flow charts of two preferred methods of calibration of a machine of FIG. 7; and

FIG. 10 is a flow chart giving more detail of part of the methods of FIGS. 8 and 9.

### DESCRIPTION OF FIRST PREFERRED EMBODIMENTS

### Measurement Apparatus

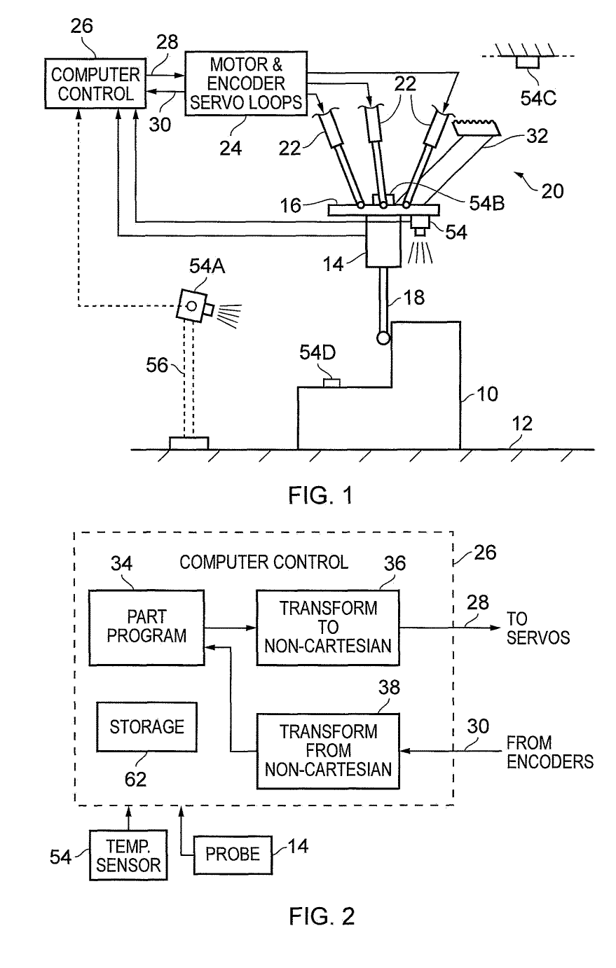

In the coordinate measuring machine shown in FIG. 1, a workpiece 10 which is to be measured is placed on a table 12 (which forms part of the fixed structure of the machine). A probe having a body 14 is mounted to a movable platform member 16. The probe has a displaceable elongate stylus 18, which in use is brought into contact with the workpiece 10 in order to make dimensional measurements.

The movable platform member 16 is mounted to the fixed structure of the machine by a supporting mechanism 20, only part of which is shown. In the present example, the supporting mechanism 20 is as described in International Patent Applications WO 03/006837 and WO 2004/063579. It comprises three telescopic extensible struts 22, extending in parallel between the platform 16 and the fixed structure of the machine. Each end of each strut 22 is universally pivotably connected to the platform 16 or to the fixed structure respectively, and is extended and retracted by a respective motor. The amount of the extension is measured by a respective encoder. The motor and encoder for each strut 22 form part of a servo loop controlling the extension and retraction of the strut. In FIG. 1, the three motors and encoders in their three respective servo loops are indicated generally by reference numeral 24.

The supporting mechanism 20 also comprises three passive anti-rotation devices 32 (only one of which is shown in FIG. 1). The anti-rotation devices extend in parallel between the platform 16 and the fixed structure of the machine. Each anti-rotation device constrains the platform 16 against one rotational degree of freedom. As a result, the platform 16 is movable with only three translational degrees of freedom, but cannot tilt or rotate. See U.S. Pat. No. 6,336,375 for further discussion of such anti-rotation devices.

Referring to FIG. 1 with FIG. 2, a computer control 26 positions the movable platform 16, under the control of a part program 34 which has been written for the measurement of the workpiece 10. To achieve this, the control 26 coordinates the respective extensions of the three struts 22. A program routine 36 transforms commands in X, Y, Z Cartesian coordinates from the part program to corresponding non-Cartesian lengths required of the struts. It produces demand signals 28 to each of the servo loops 24, as a result of which the three struts 22 extend or retract to position the platform 16 accordingly. Each servo loop acts in a known manner to drive the respective motor so as to cause the encoder output to follow the demand signal 28, tending to equalise them.

The control 26 also receives measurement signals 30 from the encoders which form part of the servo loops. These indicate the instantaneous non-Cartesian lengths of each of the struts 22. They are transformed back into Cartesian X, Y, Z coordinates by a program routine 38, for use by the part program 34.

The probe 14 may be a touch trigger probe, which issues a trigger signal to the computer control 26 when the stylus 18 contacts the workpiece 10. Alternatively, it may be a so-called measuring or analogue probe, providing analogue or digital outputs to the control 26, which measure the displacement of the stylus 18 relative to the body 14 of the probe in three orthogonal directions X, Y, Z. Instead of such contact probes, it may be a non-contact probe such as an optical probe.

In use, the platform 16 is moved to position the probe 14 relative to the workpiece 10, under the control of the part program, either in a point-to-point measurement pattern, or scanning the surface of the workpiece. For touch trigger measurements, when it receives the touch trigger signal the computer control 26 takes instantaneous readings of the non-Cartesian measurement signals 30 from the encoders of the struts 22, and the transform routine 38 processes these to determine an X, Y, Z Cartesian coordinate position of the point contacted on the workpiece surface. In the case of a measuring or analogue probe, the control combines the instantaneous outputs of the probe with the instantaneous values transformed into Cartesian coordinates from the measurement signals 30 of the struts. In the case of scanning, this is done at a large number of points to determine the form of the workpiece surface. If required, feedback from a measuring or analogue probe may be used to alter the demand signals 28, so that the machine moves the probe in order to keep it within a desired measuring range of the workpiece surface.

### Making and Correcting Measurements

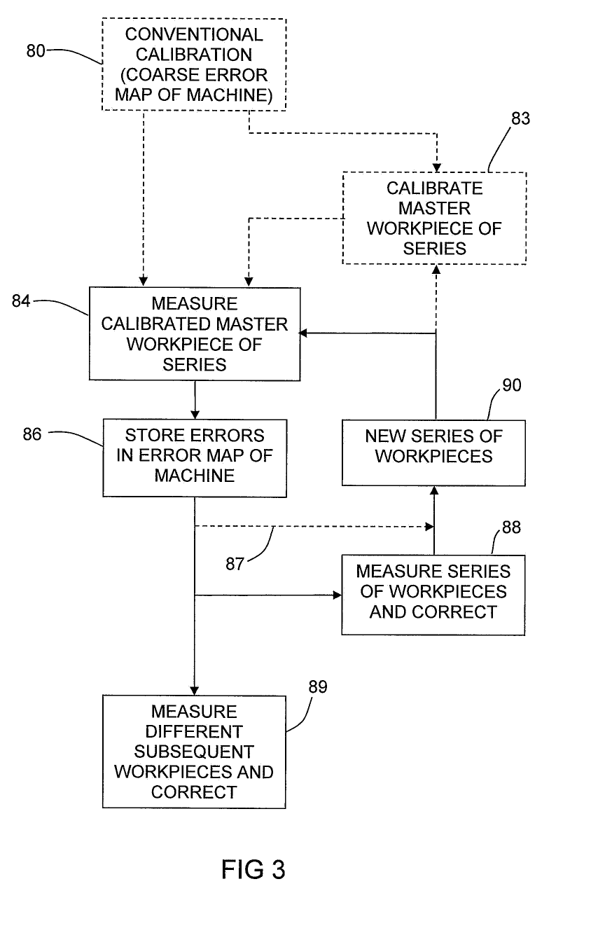

In use, the apparatus described may be used to inspect a series of workpieces which are nominally or substantially identical, e.g. as they come off a production line, or as they are manufactured on a machine tool. It may also be used to inspect multiple such series, each series having workpieces different from the preceding series, and/or which are the same as a preceding series but located at a different position or orientation on the apparatus. To do this, the computer control 26 may operate a program as shown in FIG. 3.

In an optional step 80 at the outset, the apparatus may be pre-calibrated conventionally, to produce a coarse initial error map. Any known calibration method may be used, e.g. before the apparatus leaves the manufacturer's factory, or when it is initially installed at the user's premises. Examples are shown in U.S. Pat. No. 4,919,195 (Bell et al), such as using laser interferometers and/or electronic levels. For example, as described in the introduction, a calibration fixture may be used which comprises a “forest” of multiple balls. These balls are accurately spherical, have accurately known dimensions, and they are spaced in three dimensions with accurately known relationships to each other. The fixture is placed in the working volume of the coordinate measuring apparatus and the balls are measured using the apparatus to move the probe. By comparison with the known dimensions and spacings of the balls, this produces a coarse map of the measurement errors experienced at a grid of points spread over the X, Y, Z working volume, e.g. in the form of a lookup table of correction values. Optionally, error functions such as polynomial error functions can be fitted to the errors at these points to determine errors at other points. Other calibration artefacts may be used instead of balls, e.g. ring gauges.

The coarse error map or lookup table thus produced is stored in the storage 62 of the computer control. It is stored in a sparse array, in which many values are not yet populated. With this coarse error map, the apparatus is already useful for making working measurements on workpieces. For example, if the map has error values for points spaced by 2 mm, then comparison mathematics used by the part program 34 may correct measurement values to an accuracy of, say, 200 μm. If the map has error values for points spaced by 80 μm, then the comparison mathematics may correct measurement values to an accuracy of, say, 5 μm.

This comparison mathematics suitably uses an error function which is fitted through the error values which are available in order to provide interpolation between them or extrapolation from them. The function may be a linear or quadratic function. Or other polynomial or non-polynomial functions may be used for the interpolation, e.g. cubic or quadratic spline or logarithmic functions.

When measuring a first series of nominally or substantially identical production workpieces, as part of a normal production measurement procedure, in step 84 a calibrated master or reference workpiece having known dimensions is placed on the table 12 of the CMM. The master workpiece may be a first workpiece in the series, or it may be a specially-produced artefact which has a number of features which are similar to those of workpieces in the series of workpieces. Suitably, in a step 83, it is calibrated on a separate, more accurate CMM, or measured in some other way, so that its dimensions are known accurately. For example, depending on the workpiece, 100 points at various positions on its surface may be calibrated.

In step 84, this known master workpiece is measured on the coordinate measuring apparatus, using the probe 14, at the same points as those calibrated. In step 86, the measured values are compared with the calibrated values, and the error at each point is determined (e.g. as a correction value, suitably in the form of an offset). These errors are stored in the same array as above in the storage 62 of the control 26, to further populate the error map or look-up table or to re-calculate the error function. Thus, the initial coarse error map, look-up table or function of the measuring apparatus is improved by incorporating error values determined from the measurement of the master or reference workpiece.

In one of the novel embodiments of the present invention, this improved error map, look-up table or function may now be used (in step 89) to correct measurements of subsequent workpieces different from the preceding first series, and/or which are the same as the preceding first series but located at a different position or orientation on the apparatus.

Thus, it should be noted that the error values determined from the measurement of the master or reference workpiece of the first series of workpieces are used to improve the calibration of the apparatus as a whole, not merely for improved measurement of the specific series of workpieces to which the master workpiece belongs or relates.

In step 88 of the preferred embodiment, the master workpiece is removed and the rest of the first series of nominally identical workpieces is measured. Each workpiece in turn is placed on the table 12, in the same position as the master workpiece, and is measured with the probe at the desired points. The measured values are corrected using the errors stored in the error map or look-up table in the storage 62, or by applying the stored error function. This step 88 is optional, as shown by the broken arrow 87.

In step 90 a new series of workpieces may now be selected for measurement. As for the first series of workpieces, this new series comprises nominally or substantially identical production workpieces. However, they are different from the workpieces of the first series, and/or located at a different position or orientation on the apparatus. In this case, therefore, the subsequent workpiece which is measured in step 89 may in filet form part of a new series in step 90. It is also possible to measure separate workpieces in step 89 in addition to the new series in step 90.

The new series of workpieces selected in step 90 can be measured in the same way as the first series. A calibrated master or reference workpiece of the new series is measured on the apparatus (step 84). The master workpiece may have been calibrated on a separate more accurate measuring apparatus (step 83). The error values for this new master workpiece are again stored in the array in the storage 62 (step 86), in order to further populate the error map. Or an error function is recalculated using the further error values. And the new series of workpieces are measured and corrected using the errors stored in the error map (step 88).

Over time, as more and more different series of workpieces are measured, the error map or look-up table will become better populated. Effectively, the error map becomes a more and more accurate map of the errors at numerous points over the X, Y, Z, working volume of the apparatus. This enables a subsequent workpiece (step 89) or series of workpieces (step 90) to be measured and corrected just using the existing error map, without proceeding again through the steps 83, 84 and 86 with a calibrated master workpiece of the new series. Similarly, if an error function is produced, it becomes more and more accurate over time so that it can be used to correct a subsequent workpiece without proceeding again through the steps 83, 84 and 86.

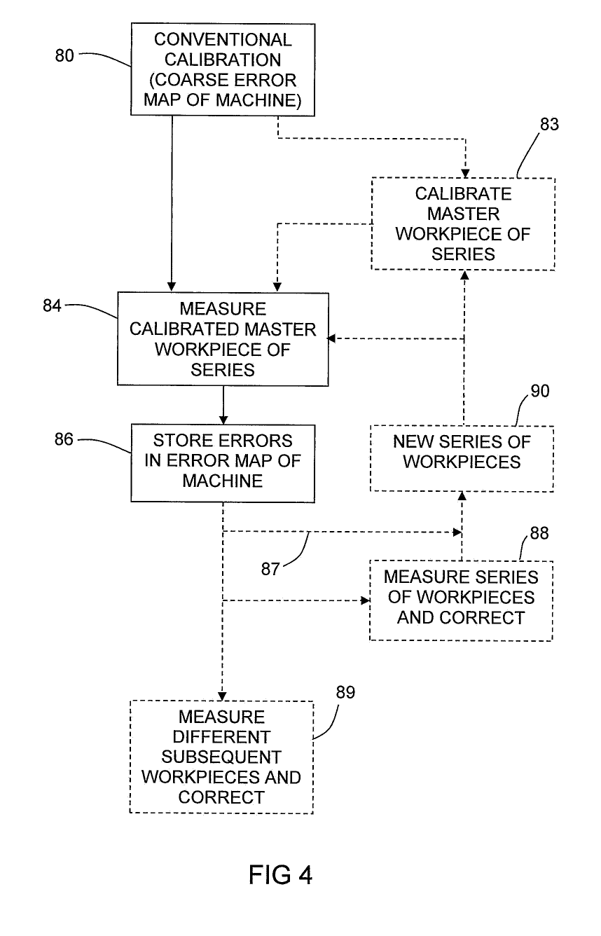

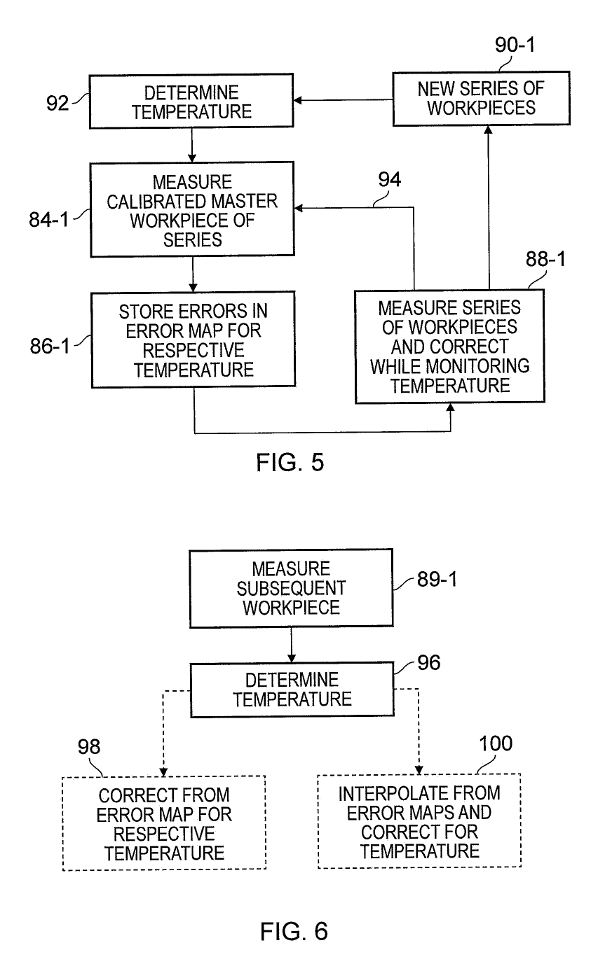

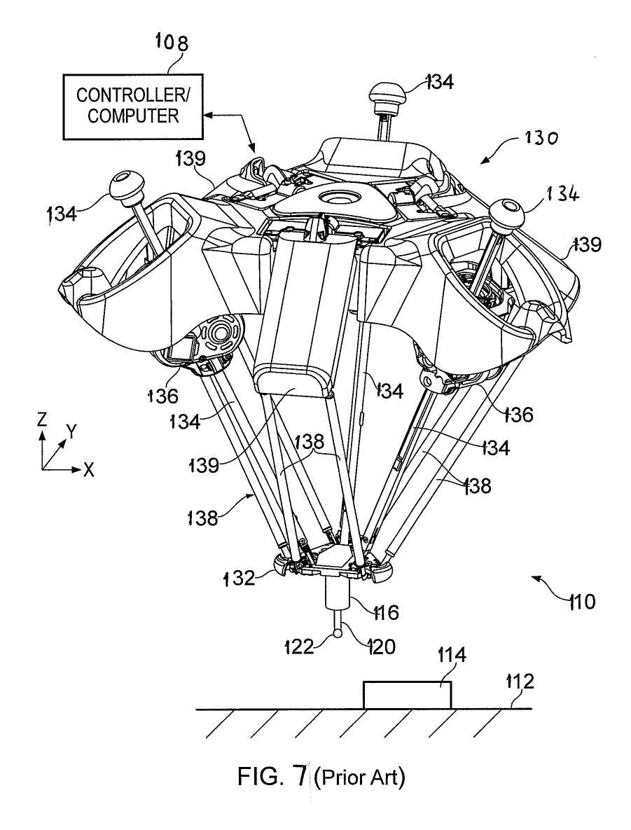

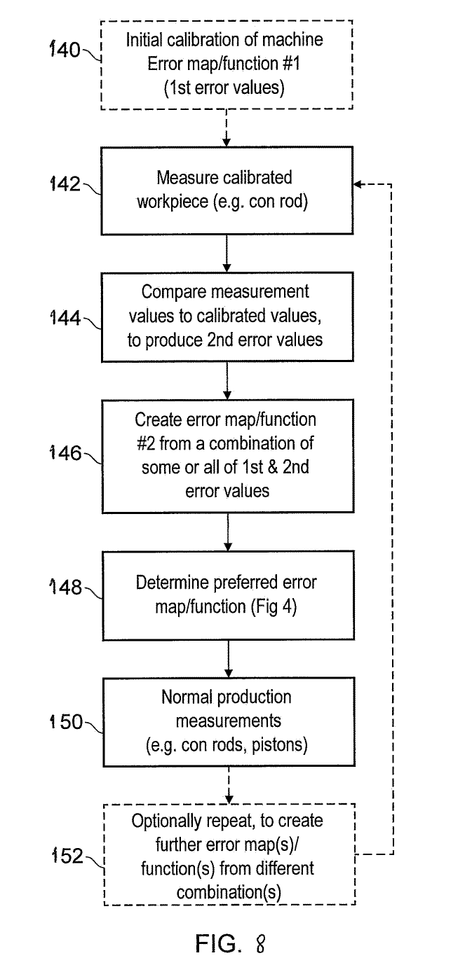

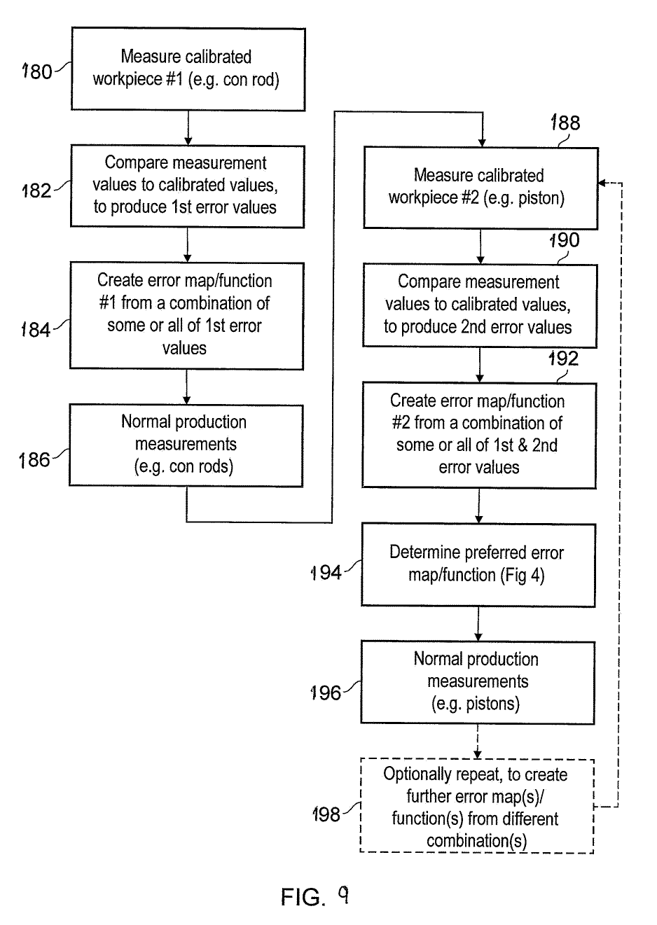

FIG. 4 shows the same steps as in FIG. 3. However, to illustrate the preferred steps of an alternative novel embodiment of the present invention, different steps have been emphasised using solid arrows instead of broken arrows. In this embodiment, the coarse initial calibration of the apparatus is undertaken (step 80) to produce an initial error map or look-up table or error function of the apparatus. This is performed in any known manner, e.g. using standard calibration artefacts, or laser interferometers, electronic levels etc.

This initial error map or look-up table or function is then improved as in steps 84 and 86 above. A master calibrated workpiece is measured (step 84). The master calibrated workpiece is one of a series of workpieces (or has a number of features which are similar to those of workpieces in the series). The errors (correction values) determined from this measurement are stored in the error map or used to re-calculate the error function. The other steps 88, 89, 90 may optionally follow as described above.

It is not necessary for all the steps of FIGS. 3 and 4 to be fully automated. For example, software running in the computer control 26 can be used to guide the user to perform the required steps.

One advantage of the method described is that it is not necessary to carry out a full calibration of the apparatus to produce an error map over its entire working volume, which is normally a time-consuming operation, perhaps taking several days. Instead, the apparatus “learns” its error map over time, during its normal day-to-day use for measuring workpieces.

It will be appreciated that, once the error map has been populated with sufficient error values, the apparatus can also be used to measure single workpieces, not merely a series for which a calibrated workpiece is available. It is used as if it had been fully calibrated in the conventional manner.

The error map which is populated as above may take the form of a lookup table, from which appropriate correction values are derived as required in order to correct measurements. The correction values value may be taken directly from the table, or they may be derived indirectly, e.g. by interpolation between or extrapolating from values in the table. Or as described above, an error function (e.g. a polynomial or non-polynomial error function) may be calculated, and recalculated as the system “learns” from the measurements of succeeding series of workpieces.

### Thermal Compensation

The embodiment of the invention shown in FIG. 1 includes an infra-red temperature sensor 54, which may conveniently be mounted on the movable platform member 16 in order to address the workpiece 10 being measured and measure its temperature. Alternatively, an infra-red sensor 54A may be mounted to the fixed structure of the CMM, e.g. on an optional bracket or stand 56, in order to measure the workpiece temperature. Such an infra-red sensor may simply take an average reading of the temperature of an area of the workpiece surface, or it may be a thermal imaging sensor arranged to recognise and take the temperature of a specific workpiece feature.

In another alternative, if the CMM has facilities for automatically exchanging the probe 14, then it may be exchanged for a contact temperature sensor (not shown) which is brought into contact with the surface of the workpiece 10 and dwells there for a period in order to measure its temperature. Such an exchangeable contact temperature sensor is described in U.S. Pat. No. 5,011,297. Or a temperature sensor (such as a thermocouple) may be placed manually on the surface of the workpiece, as shown at 54D.

In a further alternative, a simple environmental temperature sensor of any suitable type (e.g. a thermocouple) may be provided in order to take the environmental temperature rather than specifically measuring the temperature of the workpiece. FIG. 1 shows such an alternative temperature sensor 54B, mounted to the platform 16 or to the probe 14. In this position it can measure the environmental temperature in the vicinity of the workpiece 10, without undue influence from heat generated by the motors. Another option is an environmental temperature sensor 54C, mounted to the fixed structure of the machine, or separately from it, so as to take the background environmental temperature.

It is possible to use two or more temperature sensors, for example one close to the workpiece such as the sensor 54 or 54B or 54D, plus another such as 54C which takes the background environmental temperature. The control 26 may then be programmed to use a weighted average of the readings from the two or more temperature sensors, e.g. 90% from the background sensor and 10% from the sensor close to the workpiece. The relative weightings may be adjusted by trial and error to obtain good results.

The temperature readings are taken to the control 26 and may be used to enable measurements to be compensated for thermal expansion and contraction as the temperature changes. This temperature compensation may for example proceed as described in our co-pending International Patent Application No. WO 2013/021157, incorporated herein by reference.

Since dimensional measurements depend on the temperature at which they are made, it is particularly advantageous that the error map or lookup table or error function should be related to a specific temperature. Thus, if the CMM is pre-calibrated with an initial error map or lookup table or function (step 80), then this should relate to a particular temperature, e.g. a standard temperature such as 20° C. All succeeding measurements which contribute to further populating the error map or lookup table or recalculating the error function should likewise be taken at that temperature, to within a predetermined tolerance. Or they should be compensated to that temperature as in the above co-pending applications, or for example using the known coefficient of thermal expansion of the workpiece material.

In a further preferred method according to the invention, a plurality of error maps, lookup tables or error functions are built up, each one relating to a specific temperature. This is illustrated in FIG. 5.

FIG. 5 shows steps 84-1, 86-1, 88-1 and 90-1. These correspond respectively to the steps 84, 86, 88 and 90 in FIGS. 3 and 4. They proceed in the same way as described above, except as follows, and so reference should be made to the above description for further details.

Before (or possibly after) the calibrated master workpiece is measured in step 84-1, the temperature of the measurement is also determined in a step 92, by reading one or more temperature sensors such as the sensors 54 or 54A-54D. Then, in step 86-1, the errors are stored in an error map which relates (within a predetermined tolerance) to the temperature as thus determined. (Or it may be used to calculate an error function which similarly relates to that temperature.)

Subsequent determinations to monitor the measurement temperature take place during step 88-1, as the series of workpieces is measured and corrected. If the temperature remains within the predetermined tolerance, then corrections are made from the error map, look-up table or error function for that temperature.

If it is determined that the temperature has changed by more than the predetermined tolerance, then a further iteration of the steps 84-1 and 86-1 takes place, as indicated by an arrow 94. The calibrated master workpiece is replaced on the table 12 of the machine, it is measured, and the correction values are stored in a different error map or look-up table relating (to within a predetermined tolerance) to the new temperature. Thus, a separate error map or look-up table is built up for each of a number of different measurement temperatures. Or the correction values may be used to calculate or recalculate an error function which similarly relates to that temperature.

In step 88-1, the errors are corrected using the appropriate map, table or function corresponding to the temperature at which the measurements take place.

When a new series of workpieces is to be measured, step 90-1 proceeds with a further iteration of the steps 92, 84-1, 86-1 and 88-1. The correction values produced in step 84-1 for the new master workpiece of the new series are used to build up or improve the error map or look-up table or error function which relates (to within the predetermined tolerance) to the temperature as determined in step 92. During measurements on subsequent workpieces of the new series in step 88-1, the temperature is monitored, and if it changes beyond the predetermined tolerance the master workpiece is again measured to build up or improve a different error map or table or function, relating to the changed temperature.

In the case of an error function, the above description has suggested that a separate function is built up for each temperature. However, it is instead possible to build up one error function which includes a term relating to the variation of measurement errors (over the working volume of the machine) with the temperature of the measurement. This is within the ordinary skill of a person skilled in the present field.

FIG. 6 shows possible ways in which the correction of measurements of subsequent workpieces can be performed, taking account of the temperature of the measurement. This can be either in step 88-1, FIG. 5, or in step 89, FIGS. 3 and 4. The subsequent workpiece is measured in a step 89-1. Before or after this, the temperature of the measurement is determined (step 96), using temperature sensors such as the sensors 54 or 54A-54D. In a first option (step 98), the measurements are corrected from an error map, table or function which corresponds to the temperature thus determined, to within a predetermined tolerance.

Alternatively, if no error map, table or function corresponds with the tolerance, then in step 100 it is possible to interpolate between or extrapolate from two or more error maps, look-up tables or error functions which relate to different temperatures.

Of course, it will be appreciated that numerous modifications may be made to the above embodiments, for example as follows.

Other supporting mechanisms for moving the probe 14 can be used, rather than the supporting mechanism 20 with three extensible struts as shown in FIG. 1. For example, it is possible to use a hexapod supporting mechanism, with six extensible struts pivotably mounted in parallel between the movable member 16 and the fixed structure of the machine. Each such strut is extended and retracted by a motor and encoder forming a servo loop, as above. The extension and retraction of each strut is coordinated by the computer control, to control the movement of the movable member in five or six degrees of freedom (so the probe 14 can be orientated by tilting about X and Y axes, as well as translated in the X, y and Z directions). The outputs of the encoders are read by the computer control and transformed into Cartesian coordinates when a measurement is to be taken.

Alternatively, the supporting mechanism for the movable member 16 and the probe 14 can be a conventional Cartesian CMM, having three serially-arranged carriages which move in X, Y and Z directions respectively.

If desired, in any of the above arrangements, the probe 14 may be mounted to the movable member 16 via a probe head, which is rotatable in one or two axes to orientate the probe. Several suitable probe heads are available from the present applicants/assignees Renishaw plc. The probe head may be of the indexing type, such as the Renishaw PH10 model, which can be locked into any of a plurality of orientations. Or it may be a continuously rotatable probe head, such as the Renishaw PH20 model. Or the probe itself may have one or two axes of continuous rotation, such as the Renishaw REVO® or PH20 robe.

### DESCRIPTION OF FURTHER PREFERRED EMBODIMENTS

FIG. 7 is an illustration of parts of a coordinate measuring apparatus. The apparatus is a comparative gauging machine 110 as sold by the present applicants Renishaw plc under the trademark EQUATOR. It comprises a fixed platform 130 connected to a movable platform 132 by a parallel kinematic motion system. In the present example, the parallel kinematic motion system comprises three struts 134 which act in parallel between the fixed and movable platforms. The three struts 134 pass through three respective actuators 136, by which they can be extended and retracted. One end of each strut 134 is mounted by a universally pivotable joint to the movable platform 132, and the actuators 136 are likewise universally pivotally mounted to the fixed platform 130.

The actuators 136 each comprise a motor for extending and retracting the strut, and a transducer which measures the extension of the respective strut 134. In each actuator 136, the transducer may be an encoder comprising a scale and readhead, with a counter for the output of the readhead. Each motor and transducer forms part of a respective servo loop controlled by a controller or computer 108.

The parallel kinematic motion system also comprises three passive anti-rotation devices 138, 139 which also act in parallel between the fixed and movable platforms. Each anti-rotation device comprises a rigid plate 139 hinged to the fixed platform 130 and a parallel, spaced pair of rods 138 which are universally pivotably connected between the rigid plate 139 and the movable platform 132. The anti-rotation devices cooperate to constrain the movable platform 132 against movement in all three rotational degrees of freedom. Therefore, the movable platform 132 is constrained to move only with three translational degrees of freedom X, Y, Z. By demanding appropriate extensions of the struts 134, the controller/computer 108 can produce any desired X, Y, Z displacement or X, Y, Z positioning of the movable platform.

The principle of operation of such a parallel kinematic motion system is described in our U.S. Pat. No. 5,813,287 (McMurtry et al). It is an example of a tripod mechanism (having the three extending struts 134). Other motion systems e.g. with tripod or hexapod parallel kinematic mechanisms can be used.

Taken together, the transducers of the three actuators form a position measuring system. This determines the X, Y, Z position of the movable platform 132 relative to the fixed platform 130, by appropriate calculations in the controller or computer 108. These calculations are known to the skilled person. Like all measuring apparatus, however, the position thus determined by the position measuring system is subject to errors. Methods are discussed below for calibrating the position measuring system for these errors.

Typically an analogue probe 116 having a deflectable stylus 120 with a workpiece contacting tip 122 is mounted on the movable platform 132 of the machine, although other types of probes (including touch trigger probes) may be used. The machine moves the probe 116 relative to a workpiece 114 on a table 112 in order to carry out measurements of features of the workpiece. The X, Y, Z position of a point on the workpiece surface is derived by calculation from the transducers in the servo system, in conjunction with the outputs of the analogue probe 116. This is all controlled by the controller/computer 108. Alternatively, with a touch trigger probe, a signal indicating that the probe has contacted the surface of the workpiece freezes the X, Y, Z position value calculated from the output from the transducers and the computer takes a reading of the coordinates of the workpiece surface. If desired, for gauging operations during normal production use, automatic means such as a robot (not shown) may place each of a succession of substantially identical workpieces from a production run in at least nominally the same position and orientation on the table.

The parallel kinematic measuring apparatus of FIG. 7 is only one example of a type of measuring machine which can be used in the present invention. Other examples include measuring apparatus with serial kinematic motion systems, such as a conventional Cartesian CMM with three serially-connected carriages which are movable orthogonally in XYZ directions. This could be computer controlled or manually operated. Another possible serial kinematic machine is an inspection robot or a manual articulating arm, with multiple articulating arm members connected serially by multiple rotary joints. Whichever type of machine is used, typically it is placed in a workshop environment in order to inspect production workpieces from an automated manufacturing process.

In use, the controller or computer 108 in FIG. 7 contains a program which causes the probe 116 to scan the surface of the workpiece 114. Or for a touch trigger probe it causes it to contact the surface of the workpiece at a plurality of different points, sufficient to take all the required dimensions and form of the workpiece for the inspection operation required. This controller/computer may also be used to run programs which control the calibration methods which will be described below.

The calibration methods will be described with reference to the comparative gauging machine 110 of FIG. 7, but the same methods can be performed on other measuring apparatus such as the serial kinematic machines mentioned above.

FIG. 8 illustrates a first example of such a calibration method. The machine 110 has an initial error map or error function, derived by an initial calibration which is performed in a conventional manner in step 140. This may be a preliminary step performed by the manufacturer of the machine, before or during its installation at the user's premises. Because it may not be part of the method performed by the user, step 140 is shown in broken lines. However, it is also possible for this initial calibration to be performed by the user after installation of the machine.

For the conventional initial calibration in step 140, typically the machine is used to make numerous measurements of dimensionally calibrated reference standards, at numerous locations in the working volume of the machine. The reference standards are preferably calibrated in a manner which is traceable to appropriate national or ISO standards. They may for example be ring gauges, reference spheres, gauge blocks such as length bars or step gauges, straight edges, etc. Or another calibration artefact may be used, such as a “forest of balls”, comprising a number of spheres mounted to a base plate fixture on sterns or stalks. These spheres are accurately spherical, have accurately known dimensions, and they are mounted so as to be spaced in three dimensions with accurately known relationships to each other. The fixture is placed in the working volume of the coordinate measuring apparatus and the spheres are measured using the apparatus to move the probe. By comparison with the known dimensions and spacings of the spheres, this produces a coarse map of the measurement errors experienced at a grid of points spread over part or all of the X, Y, Z working volume of the machine. It is also possible to make measurements using a telescoping ball bar or a laser interferometer as a reference standard, as is conventional.

The initial error map in step 140 comprises first error values derived by comparing such measurements to the corresponding known calibrated values of the reference standards, at various locations within the machine's working volume. Alternatively an initial error function may be derived from such error values. The initial error map (and the other error maps discussed in this specification) can be created as a lookup table which indicates errors in the X, Y and/or Z directions for a given X, Y, Z coordinate position in the working volume of the machine. An error function may for example be a polynomial function which enables the calculation of errors in the X, Y and/or Z directions for a given X, Y, Z coordinate position.

The initial calibration need not be to a high accuracy, and it may not cover all locations within the working volume of the machine. The purpose of the following steps is to further calibrate the machine, improving the error map or error function.

In step 142, a calibrated workpiece is placed on the table 112 of the machine 110, as shown at 114 in FIG. 7. The calibrated workpiece is one of a first series of nominally identical workpieces received from a production process, which are to be measured on the machine as part of an inspection process. By way of example, the workpieces in the first series might be con rods (connecting rods) for an automotive internal combustion engine.

Suitably the calibration of the calibrated workpiece of the first series (e.g. a con rod) may have been performed by measuring all its desired dimensions which are to be inspected, for example on a separate, more accurate coordinate measuring machine (CMM). This produces a set of calibrated values for the workpiece. The more accurate CMM may be located in a laboratory environment, whereas the machine 110 of FIG. 7 could be located on the production floor, close to the machine tools or other production machines which manufacture the workpieces.

During the measurement in step 142, all of the dimensions to be inspected of the calibrated workpiece (e.g. con rod) are measured again on the machine 110, in the conventional manner by moving the probe 116 around the workpiece. This produces a set of raw measurement values, corresponding to the calibrated values. In step 144, the raw measurement values are compared to the corresponding calibrated values, producing a second set of error values. Both the raw measurement values (from step 142) and the second error values (step 144) are stored by the computer or controller 108.

It will be appreciated that the calibration of the workpiece may take place after it has been measured on the machine 110 in step 142, rather than before. This still produces calibrated values which are compared to raw measurement values in step 144, to produce the second set of error values.

In step 146, a second error map or error function is created from a combination of some or all of the first and second error values, stored in steps 140 and 144. Alternatively, if the initial calibration produced an error function and no initial error map is available, then error values may be synthesised from the error function and combined with some or all of the second error values. As is well understood by a skilled person, algorithms may be applied to remove outliers in the error values, or to average or weight some of the values.

In practice, it may be desirable to produce not just a single instance of such a second error map or error function, but multiple further error maps or error functions. These are produced in step 146 from multiple different combinations of some or all of the available error values.

The second error map or error function may in practice give better or worse results than the initial error map or function of step 140. That is, when measurements are corrected using the second error map or error function, the results may be more or less accurate than when corrected using the first error map or error function. Likewise, if there are multiple further error maps or error functions, one may give better results than another.

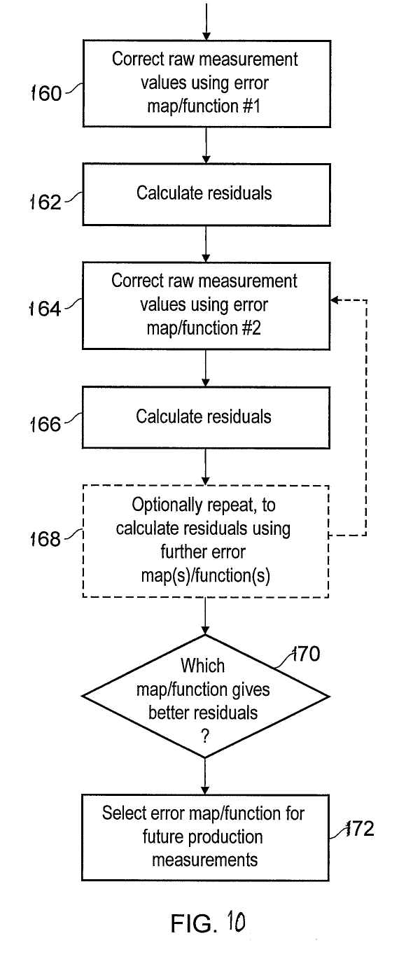

In step 148, therefore, it is determined which of the error maps or error functions (which combinations of error values) gives the best results. This is described in more detail below, with reference to FIG. 10.

The error map or error function thus determined is selected for subsequent use in measuring production workpieces (step 150). For example, further workpieces from the first series of nominally identical production workpieces (e.g. con rods) are placed on the table 112 of the machine 110 (FIG. 7). These workpieces are not calibrated, but their dimensions to be inspected are merely measured using the probe 116, giving corresponding raw measurement values. The raw measurement values are then corrected by applying the selected error map or error function. It is also possible to use the selected error map or error function to correct measurements of different workpieces, such as a piston for an automotive internal combustion engine.

As indicated at step 152, when it is desired to manufacture and inspect some different series of nominally identical workpieces (e.g. pistons or crankshafts for an automotive internal combustion engine), then steps 142-150 are repeated. One workpiece of the new series is calibrated and measured, as in step 142, and the raw measurement values are stored in the computer 108. By comparing these raw measurements with the calibrated values (step 144), further error values are created. A further error map or error function is created (step 146) by combining some or all of these error values with error values from any of the previous error maps or functions. In step 148 a choice is made as to which error map or error function should be used for future inspection of production workpieces, as described below with reference to FIG. 10. This choice can select from any of the available error maps or functions, including the initial map or function from step 140, and those produced in step 146 using combinations of error values from various workpieces.

Note that the further error map or error function will preferably combine some or all of the error values from each location or orientation, in order to maximise the coverage of the working volume of the machine. This further error map or error function is then tested in step 148 to see whether it gives better results and should be selected for future use.

The above method of Fig S starts from a conventional initial calibration of the machine (step 140). Referring to FIG. 9, a method will now be described which does not require a conventional initial calibration. This method may also be used in combination with the FIG. 8 method, for subsequent improvement of the machine's error map or error function.

Steps 180 and 182 of FIG. 9 are similar to steps 142 and 144 of FIG. 8. In step 180, a calibrated workpiece (such as a con rod) is placed on the table 112 of the machine 110. The workpiece (e.g. con rod) has been calibrated as described above in relation to FIG. 8, and it is now measured on the machine 110 giving raw measurement values. These are compared to the corresponding calibrated values in step 182, producing a first set of error values. Both the raw measurement values (step 180) and the first error values (step 182) are stored by the computer or controller 108.

In step 184, a first error map or error function of the machine 110 is created from a combination of the first set of error values. This may then form an initial error map or error function, which will be used in a manner comparable to the error map or function of step 140 of FIG. 8. If this is the first calibration of the machine, then all the error values may be used. If there is already a previous conventional initial calibration, then the first error map or function might be formed from a combination using only some of the error values, as in step 146 of FIG. 8. As previously, algorithms may be applied to remove outliers in the error values, or to average or weight some of the values.

Next, in step 186, the method continues with normal production measurements of the remainder of the first series of nominally identical workpieces (e.g. con rods), as they are manufactured. These workpieces are not calibrated, but their dimensions to be inspected are merely measured on the machine 110 of FIG. 7, giving corresponding raw measurement values. These raw measurement values are then corrected by applying the error map or error function created in step 184.

At some future time, it is desired to use the machine 110 to measure a different, second series of nominally identical production workpieces. By way of example, the workpieces of the second series might be pistons for an automotive internal combustion engine. A calibrated workpiece (e.g. a piston) from the second series is placed on the table 112 of the machine 110. It is calibrated in the same way as above, by measuring all the desired dimensions to be inspected, e.g. on a separate, more accurate CMM, producing a set of calibrated values.

In step 188, all the dimensions to be inspected of the calibrated workpiece (e.g. piston) of the second series are measured again on the machine 110, producing a set of raw measurement values corresponding to the calibrated values. In step 190, the raw measurement values are compared to the corresponding calibrated values, to produce a second set of error values. As previously, both the raw measurement values (step 188) and the error values (step 190) are stored by the computer or controller 108. Again as previously, the calibration of the workpiece (e.g. piston) may take place after the measurements on the machine 110, rather than before.

In step 192, a second error map or error function is created from a combination of some or all of the error values stored in steps 182 and 190. As previously, error values may be synthesised from an error function if necessary, e.g. if they were not stored in step 182. Again, algorithms may be applied to remove outliers in the error values, or to average or weight some of the values. As in step 146 of FIG. 8, it may be desirable to produce multiple further error maps or error functions, from multiple different combinations of some or all of the available error values.

As in FIG. 8, these second or further error maps or error functions may in practice give better or worse results than the first error map produced in step 184. That is, the results may be more or less accurate than when corrected using the first error map or error function.

In step 194, therefore, it is determined which of the error maps or error functions gives the better results. As for the corresponding step 148 in FIG. 8, this is described in more detail below, with reference to FIG. 10. The error map or error function thus determined is selected for subsequent use in measuring production workpieces.

Next, in step 196, the method continues with normal production measurements of the remainder of the second series of nominally identical workpieces (e.g. pistons), as they are manufactured. As above, these workpieces are not calibrated, but their dimensions to be inspected are merely measured on the machine 110 of FIG. 7, giving corresponding raw measurement values. These raw measurement values are then corrected by applying the error map or error function selected in step 194.

As indicated at step 198, when it is desired to manufacture and inspect some different, third or subsequent series of nominally identical workpieces (e.g. crankshafts for an automotive internal combustion engine), then steps 188-196 are repeated. This creates further error maps or error functions. In step 194 a choice is made as to which should be used for future inspection of production workpieces, as described below with reference to FIG. 10.

At step 152 in FIG. 8 and at step 198 in FIG. 9, it is suggested to repeat the procedure with a different calibrated workpiece. However, rather than measuring a different calibrated workpiece from a new series of nominally identical workpieces, it is possible to repeat the measurements of some or all of the dimensions to be inspected of a previous calibrated workpiece, but located in a different position and/or orientation on the machine 110. For example, the calibrated con rod previously used in step 142 (FIG. 8) or step 180 (FIG. 9) could be measured again in a different position or orientation. This produces further error values which are stored in step 144 or 190, and which may then be used to create a further error map or error function (step 146 or 192). Note that the further error map or error function will preferably combine some or all of the error values from each location or orientation, in order to maximise the coverage of the working volume of the machine. This further error map or error function is then tested in step 148 or 194 to see whether it gives better results and should be selected for future use.

In step 146 (FIG. 8) and steps 184 and 192 (FIG. 9), error maps or error functions are created from combinations of some or all of the error values stored in steps 140 and 144 or 182 and 190 (possibly including error values synthesised from an error function). It would be possible to create an error map or error function which merely combined all of the available error values. However, the purpose of the determination at step 148 or 194 is to find a combination of the error values which produces good results (more accurate correction of the raw measurement values), possibly also removing outliers in the sets of error values. For this, it is desirable to produce multiple error maps or error functions, from numerous different combinations of the available error values. For each error map or function, a combination is made from a different sub-set comprising only some of the available error values. The error values of the initial or first error map (or synthesised from the initial or first error function) may be combined with only some of the second error values produced in step 144 or step 190. Or error values from only a part of the initial/first error map may be combined with some or all of the second error values.

Thus, the determination which takes place in step 148 or 194 can select from numerous such error maps or error functions, created from numerous different combinations of the error values. If sufficient computing power and time is available, it would be possible to create and use error maps or error functions from all possible combinations of the error values. Alternatively, to save computing resources, combinations may be chosen selectively, for example favouring combinations which have a denser spread of error values (and/or lower error values) in a central zone of the machine's working volume, where most measurements take place.

FIG. 10 illustrates a method which can be used at step 148 of FIG. 8 or in step 194 of FIG. 9, in order to determine which of two or more error maps or error functions should be selected for future production measurements.

In step 160, the method takes raw measurement values of the calibrated workpieces as stored in step 142 (FIG. 8) or in steps 180 and 188 (FIG. 9). It also takes the first error map or error function, i.e. the initial error map or error function (FIG. 8) or the error map or error function which has been created in step 184 (FIG. 9). It uses this error map or error function to correct the raw measurement values. Where possible, it is preferable to operate on raw measurement values from more than one of the calibrated workpieces. Or, if the raw measurement values come from one particular calibrated workpiece, they may be corrected using an error map or error function which derives wholly or in part from a different calibrated workpiece.

In step 162, the accuracy of the correction performed in step 160 is assessed. This may be done by calculating a set of residuals between the corrected results and the corresponding calibration values.

In steps 164 and 166, the steps 160 and 162 are repeated, using a second, different one of the error maps or error functions created in steps 146 and 192. This gives a set of residuals which assess the accuracy of the second error map or error function.

As indicated at step 168, steps 164 and 166 may be repeated for the other error maps or functions created in steps 146 and 192, giving respective further sets of residuals.

Then, in step 170 a decision is made as to which of all the tested error maps or error functions gives the best results. This may be an automatic decision by the computer or controller 108, based upon which error map or error function gives the lowest residuals in steps 162, 166. For example, the sets of residuals for each error map or function may be compared by a least squares calculation, i.e. determining which set of residuals has the lowest sum of its squares. If desired, a weighted least squares method may be used, for example giving greater weight to residuals in a central zone of the working volume of the machine where most measurements take place.

Alternatively, step 170 may present the residuals calculated in steps 162, 166 to a skilled operator, e.g. as a display on a computer screen, and invite him/her to select a preferred error map or error function from those tested. This enables the operator to take into account other factors when selecting an error map or a function. For example, one of the error maps or error functions may give slightly poorer residuals over the entire working volume of the machine, but could be selected because it has better residuals in a central zone where most measurements take place. It is possible to store multiple error maps or functions, and subsequently to select an appropriate one of them depending on the measurement requirements of a particular workpiece or series of workpieces to be measured.

If the residuals are to be presented to an operator, they may be processed into a suitable form to assist his or her selection. For example, they may be presented as a “heat map” (a 2D or 3D graphical representation in which the values of individual residuals are represented as colours, e.g. red for large residuals, yellow/orange for medium residuals, green for small residuals).

Error maps or error functions may have been derived from measurements of specific workpieces in specific locations in the machine's working volume (e.g. a con rod in one location, a piston in a second location, and a valve housing in a third location). In this case their heat maps may appear as coloured graphical representations of the workpieces concerned in their respective locations. If the operator knows that the machine will be used to measure both pistons and valve housings in the near future, he/she may decide to select an error map or error function which offers an acceptable compromise for both, rather than the best error map/function for pistons or the best for valve housings.

Finally, in step 172, the error map or error function that is determined is selected for use in future production measurements which take place in step 150 (FIG. 8) or steps 186, 196 (FIG. 9).

Thus, in the preferred methods described above, the apparatus “learns” its underlying error map or error function over time, during its normal day-to-day use for measuring workpieces. In the embodiments described in relation to FIGS. 7-10, the error map or error function is based on combinations of error values which have been determined to give better correction of errors than would otherwise be the case. During use as a comparative gauging machine, the comparison of a specific workpiece against a corresponding calibrated workpiece takes place on top of this underlying error map/function. Eventually, the operator may have sufficient confidence in the accuracy of the underlying error map/function that he/she decides to use the machine to measure absolute coordinates and dimensions, in the traditional manner of a coordinate measuring machine, rather than just for comparative gauging measurements.

The preferred methods described above in relation to FIGS. 7-10 may be combined with the thermal compensation techniques described above for the embodiments of FIGS. 1-6, or those in our International Patent Applications Nos. WO 2013/021157 or WO 2014/181134. Those techniques produce temperature-dependent error maps or error functions. In the same way, the error maps or functions produced in FIGS. 8-10 above may be dependent on temperature. For example, in steps 142, 180 and 188, the temperature of the calibrated workpiece may be measured when the calibrated workpiece is measured on the apparatus of FIG. 7. This temperature value is stored with the corresponding error values in steps 144, 182 and 190. Then, in steps 146, 184 and 192, combinations of error values are chosen which relate to the same or a similar temperature (to within a pre-determined temperature tolerance). This produces a set of error maps or functions which relate to respective temperatures. When production workpieces are measured, their temperature is monitored, and the appropriate error map or function is used to correct the measurements.

1. A method for measuring production workpieces on a dimensional measuring apparatus, the method comprising:
measuring a master production workpiece on the measuring apparatus, the master production workpiece being one of a first series of nominally identical workpieces produced by a production process;
obtaining calibration values for the master production workpiece from a source external to said measuring apparatus;
comparing the calibration values with the measurement of the master production workpiece to produce one or more master workpiece correction values;
using said master workpiece correction values to populate or further populate an error map or lookup table or to calculate or recalculate an error function for calibrating the measuring apparatus;
measuring one or more further nominally identical workpieces of the first series produced by the production process on the measuring apparatus;
correcting the measurements of the further nominally identical workpieces of the first series using said master workpiece correction values or the error map or lookup table or the error function;
measuring one or more second workpieces on the measuring apparatus, wherein the one or more second workpieces are different from, or are differently located on the apparatus from, the nominally identical workpieces of said first series of workpieces; and
correcting the measurements of the one or more second workpieces using correction values derived by interpolation or extrapolation from said error map or lookup table or derived from said error function, wherein the error map or lookup table or error function has been produced using the master workpiece correction values.

2. A method for measuring production workpieces on a dimensional measuring apparatus, the method comprising:
measuring a master artefact on the measuring apparatus, the master artefact having a plurality of features, the size and shape of which approximate a production workpiece of a first series of nominally identical workpieces produced by a production process;
obtaining calibration values for the master artefact, from a source external to said measuring apparatus;
comparing the calibration values with the measurement of the master artefact to produce one or more master artefact correction values;
using said master artefact correction values to populate or further populate an error map or lookup table or to calculate or recalculate an error function for calibrating the measuring apparatus;
measuring one or more nominally identical production workpieces of the first series produced by the production process on the measuring apparatus;
correcting the measurements of the nominally identical workpieces of the first series using said master artefact correction values or the error map or lookup table or the error function;
measuring one or more second workpieces on the measuring apparatus, wherein the one or more second workpieces are different from, or are differently located on the apparatus from, the nominally identical workpieces of said first series of workpieces; and
correcting the measurements of the one or more second workpieces using correction values derived by interpolation or extrapolation from said error map or lookup table or derived from said error function, wherein the error map or lookup table or error function has been produced using the master artefact correction values.

3. The method according to claim 1, wherein the master workpiece correction values are used to further populate an existing error map or look-up table or to recalculate an existing error function for calibrating the measuring apparatus.

4. The method according to claim 1, wherein the master workpiece correction values are used to create a new error map or look-up table or to calculate a new error function.

5. The method according to claim 1, wherein the one or more second workpieces from part of one or more further series of workpieces, the workpieces of each series being nominally identical to other workpieces of that series, the workpieces of each series being different from or differently located on the apparatus from the workpieces already measured, the method further comprising, for each further series:
measuring an artefact, the artefact being one of the nominally identical workpieces of that series or having features, the size and shape of which approximate such a workpiece of that series;
obtaining calibration values for the artefact from a source external to said measuring apparatus;
comparing the calibration values with the measurement of the artefact to produce one or more artefact correction values; and
using said artefact correction values to further populate said error snap or lookup table or recalculate said error function.

6. The method according to claim 5, wherein the error map or look-up table or error function is used to correct the measurement of subsequent workpieces, which are different from those of said first and further series of workpieces or which are differently located on the apparatus.

7. The method according to claim 5, wherein measurements on the further series of workpieces take place at the same temperature as measurements on the first series of workpieces, to within a predetermined tolerance, so that the error map, lookup table or function relates to the temperature.

8. The method according to claim 1, wherein a respective error map or lookup table or function is produced for each of two or more temperatures at which measurements of the master production workpiece take place.

9. The method according to claim 8, further including determining a temperature at which the one or more second workpieces are measured, and then correcting the measurements of the one or more second workpieces using an error map, lookup table or function which corresponds to that temperature to within a predetermined tolerance.

10. The method according to claim 8, further including determining a temperature at which the one or more second workpieces are measured, and then correcting the measurements of the one or more second workpieces by interpolation between or extrapolation from two or more of the error maps or lookup tables or functions.

11. The method according to claim 1, wherein the measurement of the master production workpiece, from which the master workpiece correction values are produced, takes place at two or more temperatures, and an error function is produced which has a term relating to the variation of measurement errors with the temperature at which the measurement takes place.

12. The method according to claim 11, further including determining a temperature at which the one or more second workpieces are measured, and then correcting the measurements of the one or more second workpieces using said error function taking account of the temperature.

13. The method according to claim 1, wherein the measuring apparatus is a non-Cartesian coordinate measuring apparatus.

14. The method according to claim 1, wherein the measurements of the master production workpiece include coordinate measurements of individual points on the surface of the master production workpiece.

15. The method according to claim 1, wherein the measurements of the master production workpiece include measurements of dimensions of features of the master production workpiece.

16. A dimensional measuring apparatus comprising
a movable member for supporting a probe for measuring workpieces, and
a control system configured to cause the apparatus to perform the method according to claim 1.

17. A non-transitory computer-readable medium containing a program for a dimensional measuring apparatus, the apparatus comprising a computer control and a movable member for supporting a probe for measuring workpieces, wherein the program configures the computer control to cause the apparatus to perform the method according to claim 1.

18. The method according to claim 2, wherein the one or more second workpieces form part of one or more further series of workpieces, the workpieces of each series being nominally identical to other workpieces of that series, the workpieces of each series being different from or being differently located on the apparatus from the workpieces already measured, the method comprising, for each further series:
measuring a further artefact, the further artefact being one of the nominally identical workpieces of that series, or having features the size and shape of which approximate such a workpiece of that series;
obtaining calibration values for the further artefact from a source external to said measuring apparatus;
comparing the calibration values with the measurement of the further artefact to produce one or more further artefact correction values; and
using said correction values to further populate said error map or lookup table or recalculate said error function.

19. The method according to claim 18, wherein the error map or look-up table or error function is used to correct the measurement of subsequent workpieces, which are different from those of said first and further series of workpieces or which are differently located on the apparatus.

20. The method according to claim 18, wherein measurements on the further series of workpieces take place at the same temperature as measurements on the first series of workpieces, to within a predetermined tolerance, so that the error map, lookup table or function relates to the temperature.

21. The method according to claim 2, wherein a respective error map or lookup table or function is produced for each of two or more temperatures at which measurements of the master artefact take place.

22. A dimensional measuring apparatus comprising:
a movable member for supporting a probe for measuring workpieces, and
a control system configured to cause the apparatus to perform the method according to claim 2.

23. A non-transitory computer-readable medium containing a program for a dimensional measuring apparatus, the apparatus comprising a computer control and a movable member for supporting a probe for measuring workpieces, wherein the program configures the computer control to cause the apparatus to perform the method according to claim 2.

24. A method of further calibrating a dimensional measuring apparatus which is calibrated by an initial error map or error function,
the method comprising:
measuring a production workpiece on the measuring apparatus, the production workpiece being one of a first series of nominally identical workpieces produced by a production process;
comparing the measurements of the production workpiece with calibration values for the production workpiece, obtained from a source external to said measuring apparatus, to produce one or more error values;
determining one or more updated error maps or error functions which combine some or all of the error values with all or part of the initial error map or the initial error function;
determining whether one or more of the updated error maps or error functions gives better correction of measurement errors than the initial error map or error function; and
if an error map or error function is determined to give better correction, then selecting that error map or error function for use in correcting the measurements of one or more further workpieces.

25. The method according to claim 24, wherein the one or more updated error maps or error functions are determined by combining only sonic of the error values with all or part of the initial error map or with the initial error function; or by combining the error values with only part of the initial error map.

26. The method according to claim 24 including measuring one or more further workpieces, and correcting the measurements thereof using the selected error map or error function.

27. The method according to claim 24, wherein the one or more further workpieces include production workpieces from the first series of nominally identical workpieces.

28. The method according to claim 24, wherein the one or more further workpieces include production workpieces from a second series of nominally identical workpieces produced by a production process, which are different from the workpieces of the first series.

29. The method according to claim 26, wherein the one or more further workpieces include production workpieces from the first series of nominally identical workpieces.

30. The method according to claim 26, wherein the one or more further workpieces include production workpieces from a second series of nominally identical workpieces produced by a production process, which are different from the workpieces of the first series.

31. The method according to claim 24, further including:
measuring a production workpiece from a second series of nominally identical workpieces on the measuring apparatus;
comparing the measurements of the production workpiece from the second series with calibration values therefor, obtained from a source external to said measuring apparatus, to produce one or more further error values;
determining one or more further updated error maps or error functions which combine some or all of the further error values with all or part of a previously determined error map or function;
determining whether one or more of the further updated error maps or error functions gives better correction of measurement errors than a previously determined error map or error function; and
if an error map or error function is determined to give better correction, then selecting that error map or error function for use in correcting the measurements of one or more further workpieces.

32. The method according to claim 31, wherein the workpieces of the second series are different from the workpieces of the first series.

33. The method according to claim 31, wherein the workpieces of the second series are differently located on the apparatus from the workpieces of the first series.

34. The method according to claim 24, wherein the initial error map or error function is produced by measuring a production workpiece on the measuring apparatus; and comparing the measurements of the production workpiece with calibration values for that production workpiece, obtained from a source external to said measuring apparatus.

35. A method according to claim 34, wherein the production workpiece used to produce the initial error map or error function is one of said first series of nominally identical workpieces.

36. A method according to claim 34, wherein the production workpiece used to produce the initial error map or error function is one of a series of nominally identical workpieces which are different from the workpieces of the first series.

37. A non-transitory computer-readable medium containing a program for a dimensional measuring apparatus, the apparatus comprising a computer control and a movable member for supporting a probe for measuring workpieces, wherein the program configures the computer control to cause the apparatus to perform the method according to claim 24.

38. A non-transitory computer-readable medium containing a program for a dimensional measuring apparatus according to claim 37, wherein the program configures the computer control such that selecting one of the updated error maps or error functions is performed by presenting information about the error maps or error functions to an operator, and receiving a selection of an error map or error function from the operator.

39. A controller for a dimensional measuring apparatus comprising a movable member for supporting a probe for measuring workpieces, wherein the controller comprises a non-transitory computer-readable medium containing a program configured to cause the apparatus to perform the method according to claim 24.

40. A dimensional measuring apparatus comprising:
a movable member for supporting a probe for measuring workpieces, and
a control system configured to cause the apparatus to perform the method according to claim 24.
